(19) United States
(12) Patent Application Publication
(10) Pub. No.: US 2009/0055535 A1
(43) Pub. Date: Feb. 26, 2009

(54) DEPLOYING RESOURCES IN TARGET SERVER ENVIRONMENTS

(75) Inventors: Corville O. ALLEN, Morrisville, NC (US); Bin WANG, Beijing (CN)

Correspondence Address: KONRAD RAYNES & VICTOR, LLP;ATTN: IBM54, 315 SOUTH BEVERLY DRIVE, SUITE 210, BEVERLY HILLS, CA, 90212, US

(73) Assignee: INTERNATIONAL BUSINESS MACHINES CORPORATION, Armonk, NY (US)

(21) Appl. No.: 11/843,620

(22) Filed: Aug. 22, 2007

(51) Int. Cl. G06F 15/163

(52) U.S. Cl. 709/226

(57) ABSTRACT

Provided are a method, system, and article of manufacture for deploying resources in target server environments. A service description indicates at least one resource and for each resource values for properties for the resource. At least one artifact construct is created for at least one resource indicating the values for the properties for the resource. A determination is made of at least one of a plurality of target server artifact creators. The at least one artifact construct is communicated to the determined at least one target server artifact creator. The at least one target server artifact creator implements resources for a corresponding target server environment. The at least one determined target server artifact creator creates an implementation of the resource for the at least one artifact construct having the values indicated in the artifact construct for execution in the corresponding target server environment.

### BACKGROUND OF THE INVENTION

1. Field of the Invention

The present invention relates to a method, system, and article of manufacture for deploying resources in target server environments.

2. Description of the Related Art

Service Oriented Architectures provides business tasks or functionality through concrete descriptions of the services which are executable software. The implementation of these services are hidden from clients. These services are implemented and typically run within a computer system, such as Java 2 Platform, Enterprise Edition (J2EE)™ or Web Container. (J2EE is a Trademark of Sun Microsystems, Inc. in the United States and foreign countries) Web Container comprises a runtime environment for web components implemented in the WebSphere Application Server. (WebSphere is a registered trademark of International Business Machines Corp. in the United States and foreign countries). The artifacts required to run on these servers are different as each service provider in the different target environment defines different constructs for their environments. The service descriptions and interfaces remain constant regardless of the server, but the implementation and resources need to change based on the server.

Furthermore, the mapping of the services to resources can change depending on the environment which the service implementation will take place and run. The service components and descriptions remain the same and this mapping to resources usually requires a significant effort to code to that particular environment. The overhead and difficulty to map these systems prevents these service applications from being developed once and deployed on different systems, provided that there is a runtime component on those systems.

There is a need in the art for improved techniques for deploying resources in different target server environments.

### SUMMARY

Provided are a method, system, and article of manufacture for deploying resources in target server environments. A service description indicates at least one resource and for each resource values for properties for the resource. At least one artifact construct is created for at least one resource indicating the values for the properties for the resource. A determination is made of at least one of a plurality of target server artifact creators. The at least one artifact construct is communicated to the determined at least one target server artifact creator. The at least one target server artifact creator implements resources for a corresponding target server environment. The at least one determined target server artifact creator creates an implementation of the resource for the at least one artifact construct having the values indicated in the artifact construct for execution in the corresponding target server environment.

### BRIEF DESCRIPTION OF THE DRAWINGS

FIG. 1 illustrates an embodiment of a computing environment.

FIG. 2 illustrates an embodiment of a service description.

FIG. 3 illustrates an embodiment of resource properties in a service description.

FIG. 4 illustrates an example of a service description.

FIG. 5 illustrates an embodiment of an artifact creator registry.

FIG. 6 illustrates an embodiment of operations to add an entry to an artifact creator registry for a target server artifact creator.

FIG. 7 illustrates an embodiment of operations to invoke a target server artifact creator.

FIG. 8 illustrates an embodiment of operations for a target server artifact creator to create resources in target server environments.

FIG. 9 illustrates an embodiment of an architecture that may be used with the described embodiments.

### DETAILED DESCRIPTION

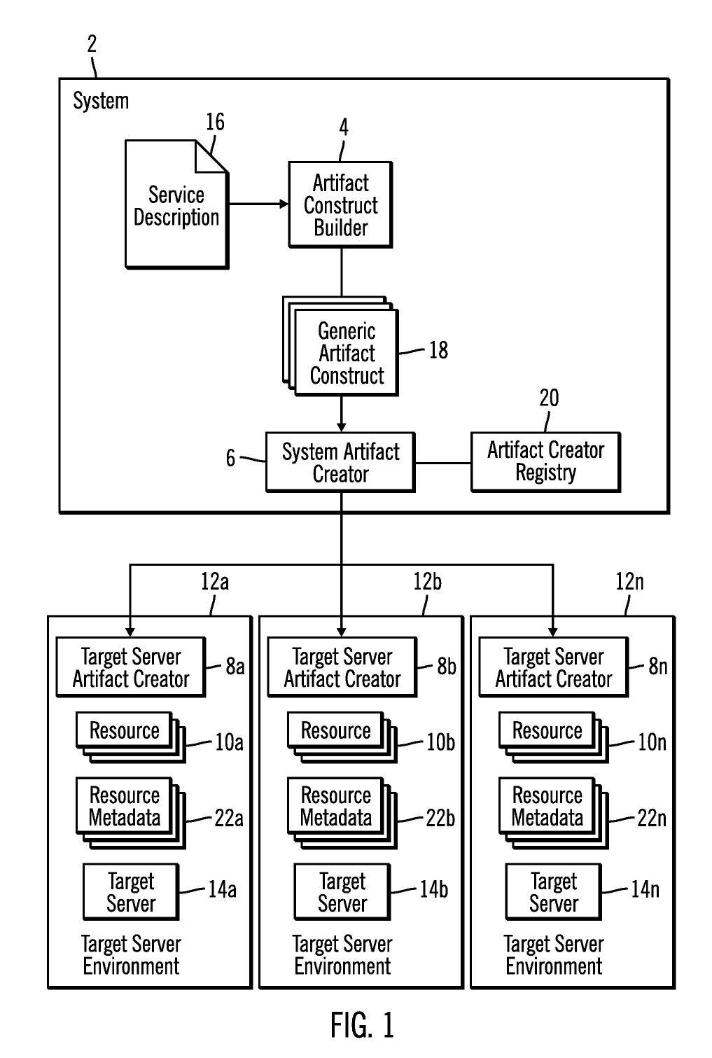

FIG. 1 illustrates an embodiment of a computing environment. A system 2 includes program components comprising an artifact construct builder 4, a system artifact creator 6, and a target server artifact creator 8a, 8b . . . 8n to create resources 10a, 10b . . . 10n in each supported target server environment 12a, 12b . . . 12n. The created resources 10a, 10b . . . 10n may enable communication and access to a target server 14a, 14b . . . 14n implementing the target server environment 12a, 12b . . . 12n. The artifact construct builder 4 receives a service description 16 providing information on resources to create and generates a generic artifact construct 18 for each resource indicated in the service description 16. The target server artifact creators 8a, 8b . . . 8n may generate resources 10a, 10b . . . 10n for their specific target server environment 12a, 12b . . . 12n from each generated generic artifact construct 18 and metadata 22a, 22b . . . 22n providing information on the generated resources, such as including the properties and values from the service description 16. The system artifact creator 6 uses an artifact creator registry 20 to determine one or more target server artifact creators 8a, 8b . . . 8n to invoke to generate and implement the resources 10a, 10b . . . 10n in their respect target server environments 12a, 12b . . . 12n.

FIG. 1 shows that the target server artifact creators 8a, 8b . . . 8n are invoked in their respective environments 12a, 12b . . . 12n to create the resources 10a, 10b . . . 10n. In one embodiment, the target server artifact creators 8a, 8b . . . 8n may be invoked in systems remote with respect to the system 2. For instance, the target server artifact creators 8a, 8b . . . 8n, resources 10a, 10b . . . 10n, and resource metadata 22a, 22b . . . 22n may be implemented in the target server 14a, 14b . . . 14n, which implements the target server environment 12a, 12b . . . 12n Alternatively, the target server artifact creators 8a, 8b . . . 8n may be implemented and invoked in the system 2.

The target servers 14a, 14b . . . 14n may implement application components in different computing environments implemented by products from the same or different vendors with resources implemented in different manners. Examples of target servers comprise a J2EE™ Server Type 1 Managed Beans based resources, J2EE™ Server Type 2 XML Bean based resources, and a WebSphere® Web Container, such as a J2EE.

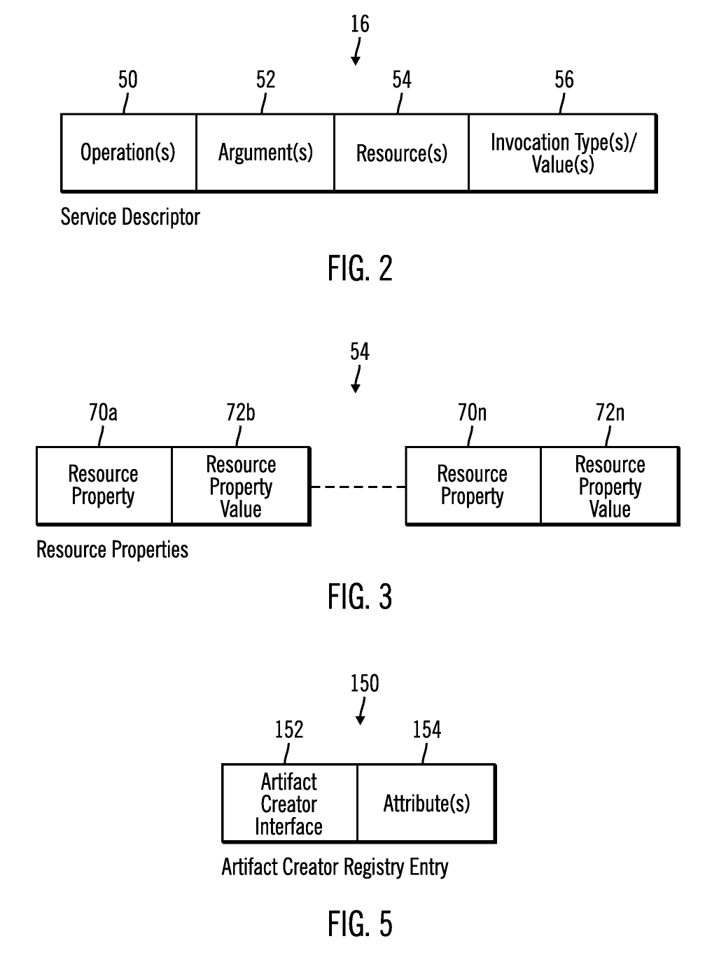

FIG. 2 illustrates an embodiment of information included in a service descriptor 16, including a description of operations 50 that are performed and arguments 52 that the indicated operations 50 receive, resources 54 that are used by the operations 50 (such as connections to servers, data sources (e.g., databases, messaging services, email stores, etc.), and one or more invocation types 56 and values for each invocation type. The invocation type may indicate how to execute the service in the target server environment 12a, 12b . . . 12n. For instance, the invocation type may indicate the running length of the process, e.g., long running, short running, etc., and whether the resource is implemented in a file, e.g., persistent. The invocation type may further specify quality of service parameters expected for the resource, such as bandwidth, access rate, etc. The service description 16 information may be implemented in a file, such as an Extended Markup Language (XML) file, text file, etc.

FIG. 3 illustrates an embodiment of the information included for each resource 54 identified in the service description 16, including a resource property 70a . . . 70n and a value 72a . . . 72n for each resource property. For instance, if the resource comprises a connection, then the resource properties may comprise a resource name and name value, a name of the entity to which to connect, such as a server, database program, email store, authentication service, etc., and a port property and value for the port.

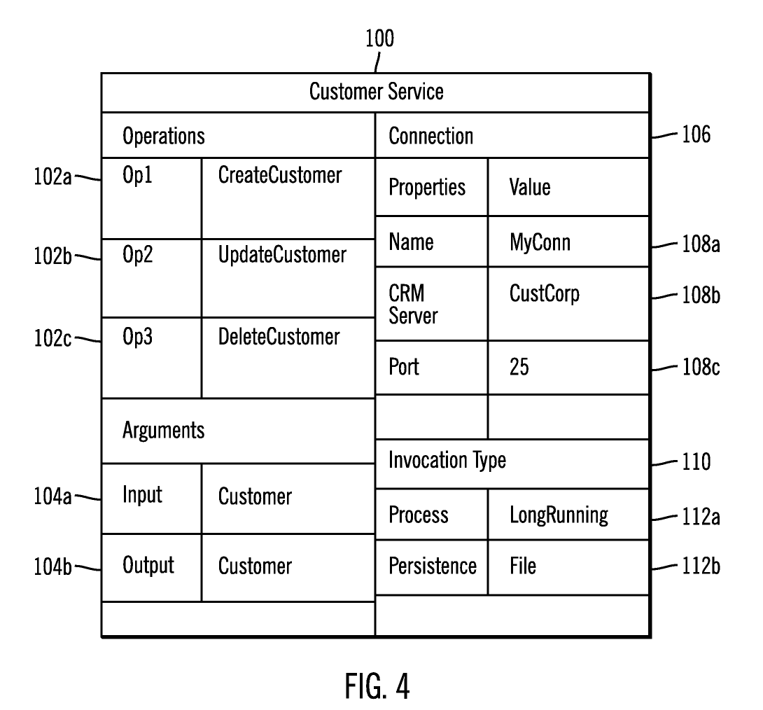

FIG. 4 illustrates an example of a service descriptor 100 for a customer service, including three operations (or methods) 102a, 102b, 102c to create a customer record in a database 102a, update a customer record in a database 102b, and delete a customer 102c record in the database. The arguments for the operations 102a, 102b, 102c comprise an input argument 104a of the customer and an output argument 104b of the customer. The resource identified in the service description 100 is for a connection 106 and includes three properties 108a, 108b, 108c of the connection comprising a name, server to which to connect and port, and values for each of these properties. The service description 100 further includes invocation types 110 comprising a process invocation type 112a indicating a duration of the execution of the resource, e.g., LongRunning, and a persistence type for the resource, indicating that the resource is maintained in a file.

FIG. 5 illustrates an embodiment of an artifact creator registry entry 150 in the artifact creator registry 20, including an artifact creator interface 152 that may be used to invoke the registered target server artifact creator 8a, 8b, 8c and one or more attributes of the artifact creator interface 152 used to select the target server artifact creator 8a, 8b, 8c. The attributes may indicate a type of the resource that will be created by the target server artifact creator 8a, 8b . . . 8n, such as an invocation type on how to execute the created resource. A target server artifact creator 8a, 8b . . . 8n may be selected from the registry 20 having attributes satisfying those requested in the service description 16, such as an invocation type or quality of service.

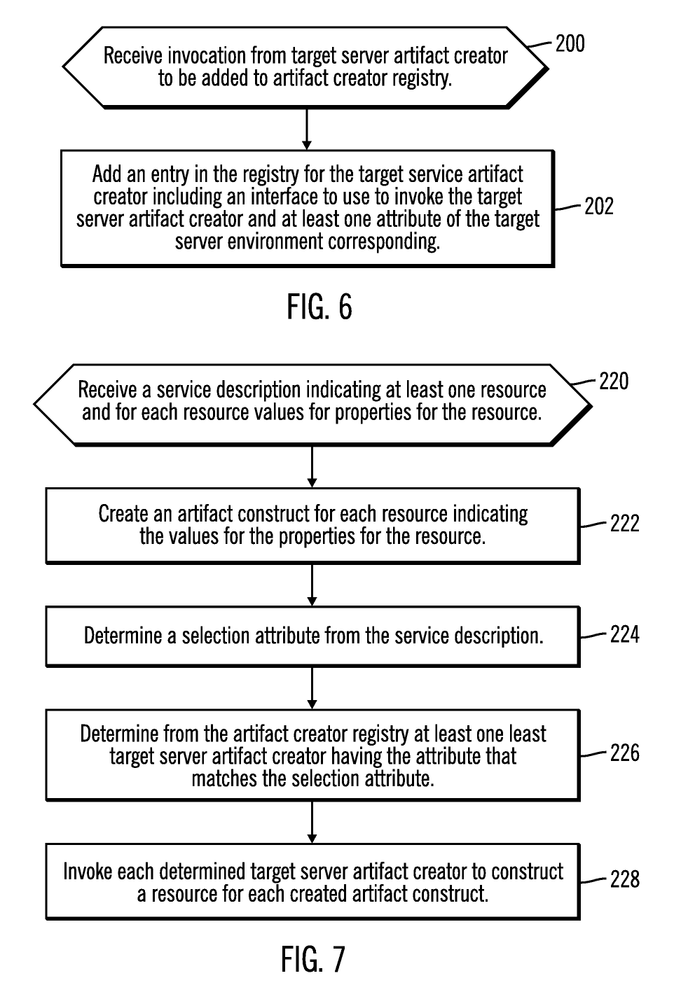

FIG. 6 illustrates an embodiment of operations performed by the system artifact creator 6 to generate entries in the artifact creator registry 20. Upon receiving (at block 200) an invocation from a target server artifact creator 8a, 8b . . . 8n to be added to the artifact creator registry 20, the system artifact creator 6 adds (at block 152) an entry 150 to in the registry 20 for the invoking target server artifact creator 8a, 8b . . . 8n including an interface 152 to use to invoke the target server artifact creator 8a, 8b . . . 8n and at least one attribute 154 of the target server artifact creator 8a, 8b . . . 8n that will create the resource 10a, 10b . . . 10n in the target server environment 12a, 12b . . . 12n, such as an invocation type, e.g., process length, an attribute of the quality of service of the resource in the environment, etc.

FIG. 7 illustrates an embodiment of operations performed by the system artifact creator 6 to invoke target server artifact creators 8a, 8b . . . 8n to create a resource 10a, 10b . . . 10n in an environment 12a, 12b . . . 12n. Upon receiving (at block 220) a service description 16 indicating at least one resource 54 and for each resource properties 70a, 70b . . . 70n and corresponding values 72a, 72b . . . 72n, the system artifact creator 6 creates (at block 222) an artifact construct 18 for each resource indicating the values 72a . . . 72n for the properties 70a . . . 70n for the resource. The system artifact creator 6 determines (at block 224) at least one selection attribute from the service description 16 to use to select target server artifact creators 8a, 8b . . . 8n to invoke. The selection attribute may comprise an invocation type, etc. The system artifact creator determines (at block 226) from the entries 150 in the artifact creator registry 20 at least one least target server artifact creator 8a, 8b . . . 8n having the attribute 154 that matches the at least one selection attribute. The system artifact creator 6 invokes (at block 228) each determined target server artifact creator 8a, 8b . . . 8n to construct a resource 10a, 10b . . . 10n for the target server environments 12a, 12b . . . 12n corresponding to the invoked target server artifact creator 8a, 8b . . . 8n. The system artifact creator 6 may use the artifact creator interface 152 indicated in the registry 20 entry to invoke the determined target server artifact creators 8a, 8b . . . 8n.

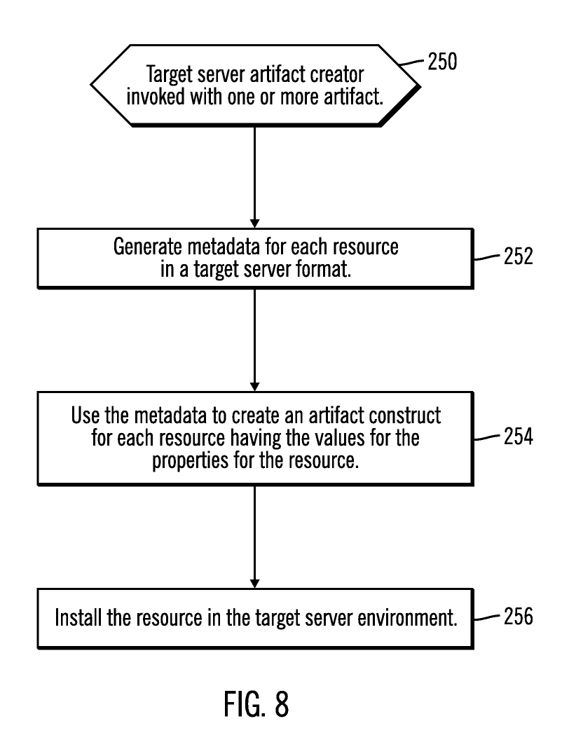

FIG. 8 illustrates an embodiment of operations performed by a target server artifact creator 8a, 8b . . . 8n to create a resource 10a, 10b . . . 10n in the target server environment 12a, 12b . . . 12n. Upon one target server artifact creator 8a, 8b . . . 8n being invoked (at block 250) with one or more artifacts 18 having resource property values 72a . . . 27n extracted from the service description 16, the target server artifact creator 8a, 8b . . . 8n generates (at block 252) resource metadata 22a, 22b . . . 22n for each resource indicated in the service description 16 in a target server format in which metadata is maintained. Thus, the metadata 22a, 22b . . . 22n created by each invoked target server artifact creator 8a, 8b . . . 8n creates metadata in a format and naming convention specific to the target sever environment 12a, 12b . . . 12n of the artifact creator 8a, 8b . . . 8n. The invoked target server artifact creator 8a, 8b . . . 8n may use (at block 254) the generated metadata 22a, 22b . . . 22n to create an artifact construct for each resource 10a, 10b . . . 10n having the values 72a . . . 72n for the properties 70a . . . 70n for the one or more resources 54 indicated in the generic artifact construction 18. The generated resource 10a, 10b . . . 10n is then installed (at block 256) in the target server environment 12a, 12b . . . 12n.

The described embodiments provide an automated building component that generates generic resource constructs that provide the mapping to different server artifacts based on a service description. This generic resource construct can then be used by target environment specific artifact creators to construct the resources in the target server environment that implement the resource properties described in the service description.

The described embodiments further allow for a service application to be deployable on disparate target servers and execute with all resources created and runnable. This promotes reuse and a familiarity of only the service description regardless of the environment the service will run on. It also allows for an extensible way to add new systems environments and provides hooks for resource creation on that environment. The generic construct allows for a well-defined input to the artifact creators minimizing the need to write-code for each resource type per server environment.

### Additional Embodiment Details

The described operations may be implemented as a method, apparatus or article of manufacture using standard programming and/or engineering techniques to produce software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

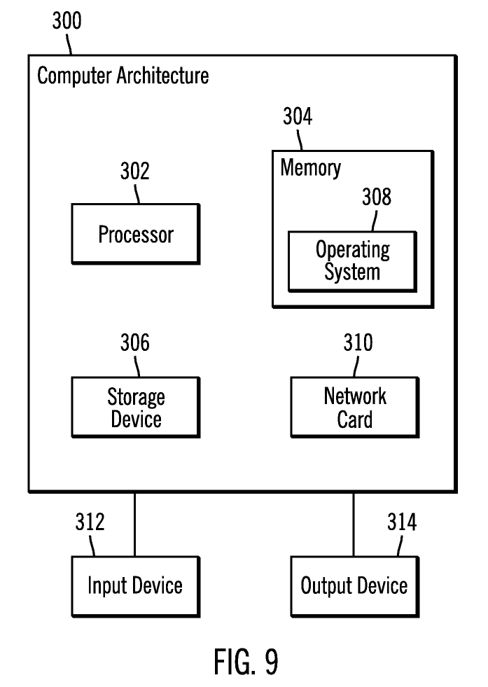

FIG. 9 illustrates one implementation of a computer architecture 200 that may be implemented in the system 2 and target server environments 12a, 12b . . . 12n of FIG. 1. The architecture 200 may include a processor 202 (e.g., a microprocessor), a memory 304 (e.g., a volatile memory device), and storage 306 (e.g., a non-volatile storage, such as magnetic disk drives, optical disk drives, a tape drive, etc.). The storage 306 may comprise an internal storage device or an attached or network accessible storage. Programs, including an operating system 308, device drivers and application programs, in the storage 306 are loaded into the memory 304 and executed by the processor 302 in a manner known in the art. The architecture further includes a network card 310 to enable communication with a network. An input device 312 is used to provide user input to the processor 312, and may include a keyboard, mouse, pen-stylus, microphone, touch sensitive display screen, or any other activation or input mechanism known in the art. An output device 314 is capable of rendering information transmitted from the processor 312, or other component, such as a display monitor, printer, storage, etc.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

The variable “n” when used to represent a variable number of an element may indicate any number of instances of the element, and may indicate different integer numbers when used with different elements or when used with different instances of the same element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of FIGS. 6, 7, and 8 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An article of manufacture including code to cause operations to be performed, the operations comprising:
receiving a service description indicating at least one resource and for each resource values for properties for the resource;
creating at least one artifact construct for at least one resource indicating the values for the properties for the resource;
determining at least one of a plurality of target server artifact creators;
communicating the at least one artifact construct to the determined at least one target server artifact creator, wherein the at least one target server artifact creator implements resources for a corresponding target server environment; and
creating, by the at least one determined target server artifact creator, an implementation of the resource for the at least one artifact construct having the values indicated in the artifact construct for execution in the corresponding target server environment.

2. The article of manufacture of claim 1, wherein the target server environment stores metadata in a target server format, further comprising:
for the at least one target server environment, generating, by the target server artifact creator, metadata for the resource in the target server format; and
using, by the determined target server artifact creator, the metadata generated for the resource in the target server format for the corresponding target server environment.

3. The article of manufacture of claim 1, wherein the service descriptor indicates a connection resource including connection properties to connect to a target server implementing the target server environment, wherein each determined target server artifact creator creates a connection resource for the corresponding target server environment to enable a client to connect to the target server for the target server environment.

4. The article of manufacture of claim 3, wherein the connection resource properties include values indicating a name of the target server and port for the connection to use to communicate with the target server.

5. The article of manufacture of claim 3, wherein the service descriptor indicates article of manufactures to perform using the connection resource and arguments for the operations.

6. The article of manufacture of claim 1, further comprising:
registering, by the target server artifact creators, with a registry;
including an entry in the registry for each target server artifact creator registering with the registry indicating an attribute of the target server environment corresponding to the registering target server artifact creator,
wherein determining the at least one of a plurality of target server artifact creators comprises determining at least one least one target server artifact creator having the attribute that matches a selection attribute.

7. The article of manufacture of claim 6, wherein the service descriptor indicates the selection attribute used to select the at least one target server artifact creator to create the resources.

8. The article of manufacture of claim 7, wherein the selection attribute comprises an invocation type indicating a running time attribute of a duration during which the resource being implemented is executed.

9. A system, comprising:
a plurality of targets server artifact creators;
an artifact construct builder executed to perform operations, the operations comprising:
receiving a service description indicating at least one resource and for each resource values for properties for the resource;
creating at least one artifact construct for at least one resource indicating the values for the properties for the resource;
a system artifact creator executed to perform operations, the operations comprising:
determining at least one of the target server artifact creators; and
communicating the at least one artifact construct to the determined at least one target server artifact creator, wherein the at least one target server artifact creator implements resources for a corresponding target server environment; and
wherein the at least one determined target server artifact creator is executed to create an implementation of the resource for the at least one artifact construct having the values indicated in the artifact construct for execution in the corresponding target server environment.

10. The system of claim 9, wherein the target server environment stores metadata in a target server format, wherein the determined at least one target server artifact creator is further executed to:
generate metadata for the resource in the target server format for the corresponding target server environment; and
use the metadata generated for the resource in the target server format for the corresponding target server environment.

11. The system of claim 9, wherein the service descriptor indicates a connection resource including connection properties to connect to a target server implementing the target server environment, wherein the at least one determined target server artifact creator further creates a connection resource for the corresponding target server environment to enable a client to connect to the target server for the target server environment.

12. The system of claim 11, wherein the connection resource properties include values indicating a name of the target server and port for the connection to use to communicate with the target server.

13. The system of claim 9, further comprising:
wherein the target server artifact creators further register with a registry;
wherein the system artifact creator includes an entry in the registry for each target server artifact creator registering with the registry indicating an attribute of the target server environment corresponding to the registering target server artifact creator, and
wherein the system artifact creator determines the at least one target server artifact creator by determining at least one least one target server artifact creator having the attribute that matches a selection attribute.

14. The system of claim 13, wherein the service descriptor indicates the selection attribute used to select the at least one target server artifact creator to create the resources.

15. A method, comprising:
receiving a service description indicating at least one resource and for each resource values for properties for the resource;
creating at least one artifact construct for at least one resource indicating the values for the properties for the resource;
determining at least one of a plurality of target server artifact creators;
communicating the at least one artifact construct to the determined at least one target server artifact creator, wherein the at least one target server artifact creator implements resources for a corresponding target server environment; and
creating, by the at least one determined target server artifact creator, an implementation of the resource for the at least one artifact construct having the values indicated in the artifact construct for execution in the corresponding target server environment.

16. The method of claim 15, wherein the target server environment stores metadata in a target server format, further comprising:
for the at least one target server environment, generating, by the target server artifact creator, metadata for the resource in the target server format; and
using, by the determined target server artifact creator, the metadata generated for the resource in the target server format for the corresponding target server environment.

17. The method of claim 15, wherein the service descriptor indicates a connection resource including connection properties to connect to a target server implementing the target server environment, wherein each determined target server artifact creator creates a connection resource for the corresponding target server environment to enable a client to connect to the target server for the target server environment.

18. The method of claim 17, wherein the connection resource properties include values indicating a name of the target server and port for the connection to use to communicate with the target server.

19. The method of claim 15, further comprising:
registering, by the target server artifact creators, with a registry;
including an entry in the registry for each target server artifact creator registering with the registry indicating an attribute of the target server environment corresponding to the registering target server artifact creator,
wherein determining the at least one of a plurality of target server artifact creators comprises determining at least one least one target server artifact creator having the attribute that matches a selection attribute.

20. The method of claim 19, wherein the service descriptor indicates the selection attribute used to select the at least one target server artifact creator to create the resources.
